(19) United States
(12) Patent Application Publication
(10) Pub. No.: US 2024/0416164 A1
(43) Pub. Date: Dec. 19, 2024

(54) FIRE SUPPRESSANT AGENT CONTAINER SYSTEM WITH PASSIVE COOLING

(71) Applicant: Williams Fire & Hazard, LLC, Port Arthur, TX (US)

(72) Inventors: Eric LaVergne, Port Neches, TX (US); John Dewey Morrison, Porterfield, WI (US); James Morgan, Port Arthur, TX (US); Dennis Crabtree, Port Arthur, TX (US)

(21) Appl. No.: 18/742,933

(22) Filed: Jun. 13, 2024

Related U.S. Application Data
(60) Provisional application No. 63/508,376, filed on Jun. 15, 2023.

(51) Int. Cl. A62C 35/02

(52) U.S. Cl. CPC A62C 35/02

(57) ABSTRACT

A container system is provided for cooling a fire suppressant agent container. The container system may employ an outer container that partially or fully encloses the fire suppressant agent container. The outer container may include inlets and outlets to direct air flow to the inner volume and passively cool the fire suppressant agent container. The outer container may include any number of inlets and outlets and may be located to catch any moving air and/or cross winds. The outer container may facilitate convective cooling of the fire suppressant agent container and additionally provide shade and protection from the environment for the fire suppressant agent container while mitigating radiative heat transfer.

### BACKGROUND

The present disclosure relates to the storage of fire suppressant agent. More specifically, the present disclosure relates to cooling storage units of fire suppressant agent.

### BRIEF DESCRIPTION OF THE DRAWINGS

FIG. 1 is a diagram of a fire suppression system for providing fire suppressant agent to equipment or a zone, according to some embodiments.

FIG. 2 is a perspective view of an outer container for a container of fire suppressant agent, according to some embodiments.

FIG. 3 is a side sectional view of the outer container of FIG. 2, according to some embodiments.

FIG. 4 is a perspective view of the outer container of FIG. 2, according to some embodiments.

FIG. 5A is a side sectional view of the outer container of FIG. 2, according to some embodiments.

FIG. 5B is a perspective view of an outer container, according to some embodiments.

FIG. 5C is a perspective view of an outer container, according to some embodiments.

FIG. 5D is a perspective view of an outer container, according to some embodiments.

FIG. 5E is a side sectional view of an outer container, according to some embodiments.

FIG. 6 is perspective view of the outer container of FIG. 2, according to some embodiments.

FIG. 7A is a side sectional view of the outer container of FIG. 2, according to some embodiments.

FIG. 7B is a perspective view of an outer container with a venturi channel and wind vane, according to some embodiments.

FIG. 7C is a side sectional view of an outer container with a venturi channel and wind vane, according to some embodiments.

FIG. 7D is a perspective view of an outer container with a venturi channel and wind vane, according to some embodiments.

FIG. 8 is a perspective view of the outer container of FIG. 2, according to some embodiments.

FIG. 9 is a side view of the outer container of FIG. 8, according to some embodiments.

FIG. 10 is a side sectional view of the outer container of FIG. 9, according to some embodiments.

FIG. 11 is a perspective view of a top portion of the outer container of FIG. 8, according to some embodiments.

FIG. 12 is a side sectional view of the outer container of FIG. 2, according to some embodiments.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the FIGURES, a container system includes an outer container (e.g., an outer housing, etc.) and a fire suppressant agent container (e.g., an intermediate bulk containers or tote), according to an exemplary embodiment. The outer container defines an enclosure with an inlet to direct wind flow to an inner volume and an outlet to direct air flow out of the inner volume to thereby induce passive cooling by leveraging winds in an environment of the container system (e.g., atmospheric winds). The outer container provides an enclosure for the fire suppressant agent container that is configured to store a suppressant agent. The outer container may include any number of inlets and outlets located in different directions around a main body and one or more upper portions of the outer container to catch any cross winds. The outer container facilitates forced convective cooling of the suppressant agent and provides shade for the fire suppressant agent container to mitigate radiative heat transfer.

### Fire Suppression System

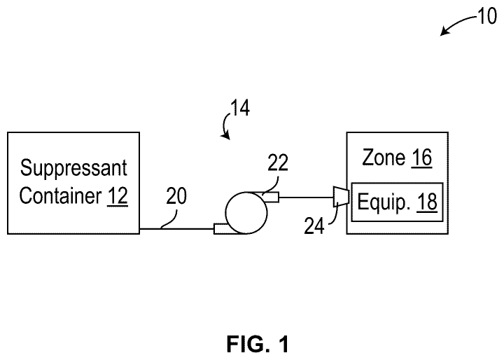

Referring to FIG. 1, a fire suppression system 10 is shown, according to an exemplary embodiment. Fire suppression system 10 includes a suppressant container 12 and distribution system 14, containing nozzles, sprinklers, dispersion devices, etc. Suppressant container 12 may include one or more tanks, reservoirs, capsules, cartridges, or intermediate bulk container (“IBC”) configured to contain/store a fire suppressant agent (e.g., a foam suppressant agent). Suppressant container 12 may fluidly couple with a prime mover (e.g., a compressed gas, a pump, etc.), shown as pump 22 through conduits 20 (e.g., pipes, lines, hoses, tubular members, etc.) that is configured to activate and deliver the fire suppressant agent from the suppressant container 12 to equipment 18 (e.g., hydrocarbon extraction equipment, field equipment, mining equipment, etc.) at a zone 16 through a nozzle 24 and the conduits 20. Fire suppression system 10 is configured to suppress a fire within the zone 16 by discharging the fire suppressant agent from the suppressant container 12 to the equipment 18 of the zone 16. Zone 16 may be a refinery, oilfield, a vehicle, an engine bay, a duct, an oil fryer, etc., or any other device, system, area, or space at which a fire may occur. In some embodiments, zone 16 is an area where equipment 18 is positioned. In some embodiments, multiple fire suppression systems 10 are used in combination with one another to cover a larger area (e.g., each in different zones).

Fire suppression system 10 can be used in a variety of different applications such as providing fire suppressant agent to equipment in a zone. Other applications can generally include different types of fire suppressant agent and different levels of mobility. Fire suppression system 10 is usable with a variety of different fire suppressant agents, such as powders, liquids, foams, or other fluid or flowable materials. Fire suppression system 10 can be used in a variety of stationary applications. By way of example, fire suppression system 10 is usable in kitchens (e.g., for oil or grease fires, etc.), in libraries, in data centers (e.g., for electronics fires, etc.), at filling stations (e.g., for gasoline or propane fires, etc.), or in other stationary applications. Alternatively, fire suppression system 10 can be used in a variety of mobile applications. By way of example, fire suppression system 10 can be incorporated into land-based vehicles (e.g., firetrucks, mobile fire suppression equipment, racing vehicles, forestry vehicles, construction vehicles, agricultural vehicles, mining vehicles, passenger vehicles, refuse vehicles, etc.), airborne vehicles (e.g., jets, planes, helicopters, etc.), or aquatic vehicles, (e.g., ships, submarines, etc.).

### Outer Container

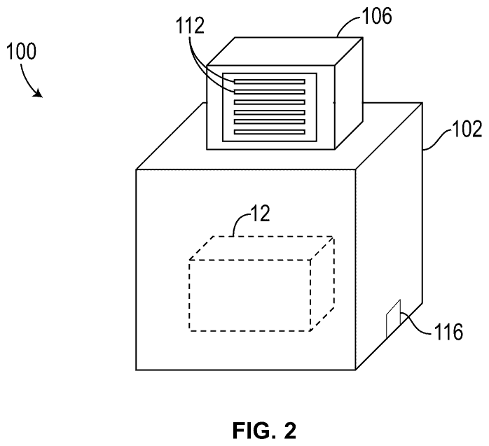

Referring now to FIGS. 2-7D, a container system 100 (e.g., an assembly, a fire suppressant container system, a fire suppression agent container system, etc.) includes the suppressant container 12 and an outer container 100 (e.g., a housing, a removable structure, a portable structure, an air guide, etc.) within which the suppressant container 12 is provided. The outer container 100 includes a main portion 102 (e.g., a body, an enclosure, a housing, sidewalls, IBC, tote, a bin, etc.) that defines an inner volume 104 within which the suppressant container 12 is positioned. The outer container 100 is configured to provide shade for the suppressant container 12 to reduce radiative heat transfer to the suppressant container 12 from sunshine. The outer container 100 is also configured to facilitate airflow over, around, underneath, etc., the suppressant container 12 to induce forced convective cooling of the suppressant container 12. In some embodiments, the suppressant container 12 is provided in or as an IBC container. In some embodiments, the suppressant container 12 has a size of approximately 1 cubic meter. Multiple suppressant containers 12 may be positioned within the outer container 100. The outer container 100 is configured to facilitate passive cooling of the fire suppressant agent that is stored within the suppressant container 12. Maintaining the foam suppressant agent within the suppressant container 12 is advantageous to maintain a suppression efficacy of the foam suppressant agent. Accordingly, the outer container 100 facilitates improved fire suppression ability of the fire suppression system 10 by providing portable and removable outer containers 100 that cool the foam suppressant agent without requiring electrical energy consumption (e.g., using a fan or a liquid cooling system for the foam suppressant agent). The outer container 100 can also be sized specifically for the suppressant container 12 or configured to enclose multiple modular suppressant containers 12. The outer container 100 may be configured to interlock or interface with the suppressant container 12 to reduce a likelihood that the outer container 100 is blown off the suppressant container 12 by excessive wind gusts.

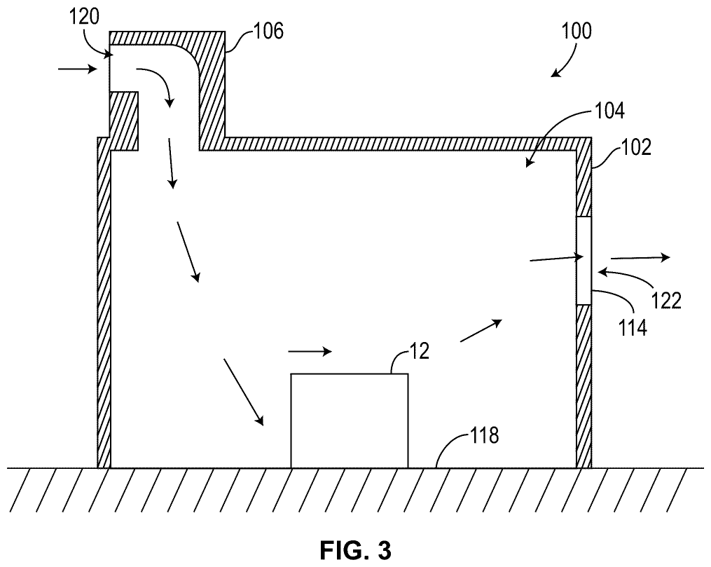

Referring to FIGS. 2-3, the outer container 100 includes the main portion 102 and an upper portion 106. The suppressant container 12 is positioned within the inner volume 104 of the main portion 102 upon a surface 118 (e.g., a ground surface, etc.). The main portion 102 rests upon or is coupled to the surface 118 and encloses the suppressant container 12. The upper portion 106 extends or protrudes vertically from a top of the main portion 102 and is configured to catch a sidewind. The upper portion 106 includes an opening 120 that is fluidly coupled with a channel (e.g., an inner volume) that extends through the upper portion 106 and fluidly couples with the inner volume 104. The main portion 102 includes an opening 122 formed in a rear wall 114 of the main portion 102. The opening 122 may be positioned vertically lower than the opening 120 in the upper portion 106. A flow path is defined between the opening 120 (e.g., the inlet), the inner volume 104, and the opening 122 (e.g., the outlet). Wind may enter the inner volume 104 through the opening 120 of the upper portion 106, flow past the suppressant container 12 to induce forced convective cooling of the suppressant container 12 (e.g., to maintain temperature of the suppressant container 12 and the fire suppressant agent within the suppressant container 12 at a desired value or below a threshold such as 115 or 120 degrees Fahrenheit to thereby reduce a likelihood of the fire suppressant agent “cooking” off), and exit the inner volume 104 through the opening 122.

Referring to FIGS. 2, 4, and 6, the upper portion 106 may include a grate, a baffle, a plurality of louvres, etc., shown as vents 112, according to some embodiments. The vents 112 are positioned over the opening 120 and are configured to direct airflow into the inner volume 104.

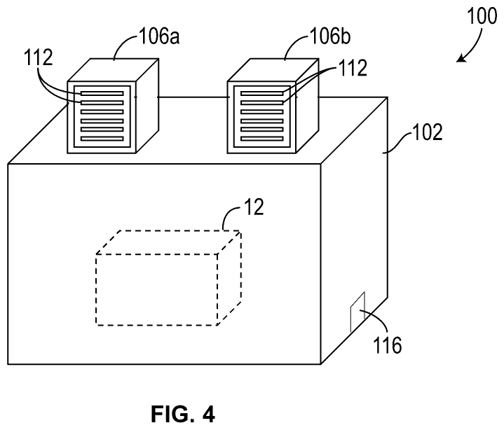

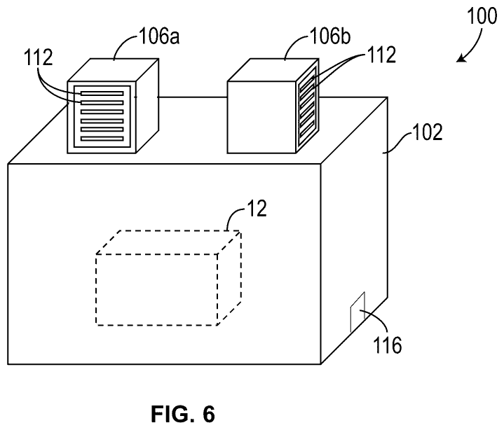

Referring to FIG. 4, the outer container 100 may include multiple upper portions 106, shown as upper portion 106a, and upper portion 106b. The upper portions 106a and 106b are both oriented in a same direction and define two inlets for wind or air to enter the inner volume 104 through the vents 112 and the openings 120 of the upper portions 106 such that an increased flow of air passes the suppressant container 12, according to one embodiment. In other embodiments, as shown in FIG. 6, the upper portions 106a and 106b are oriented in different directions relative to each other.

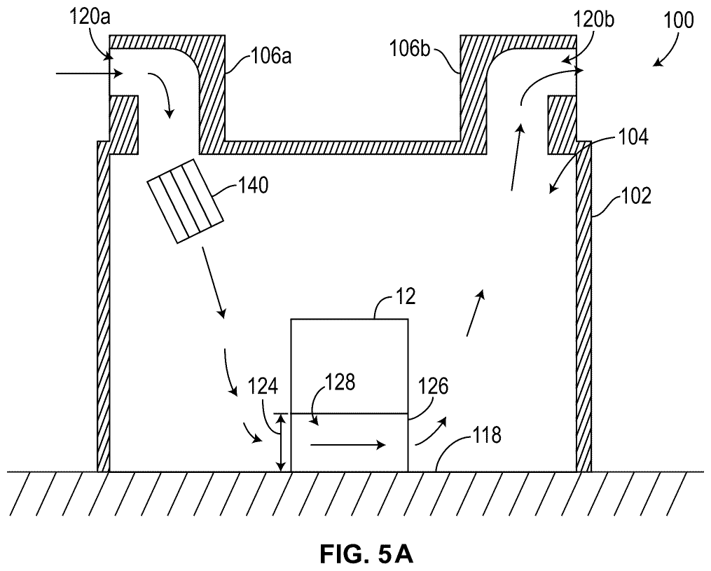

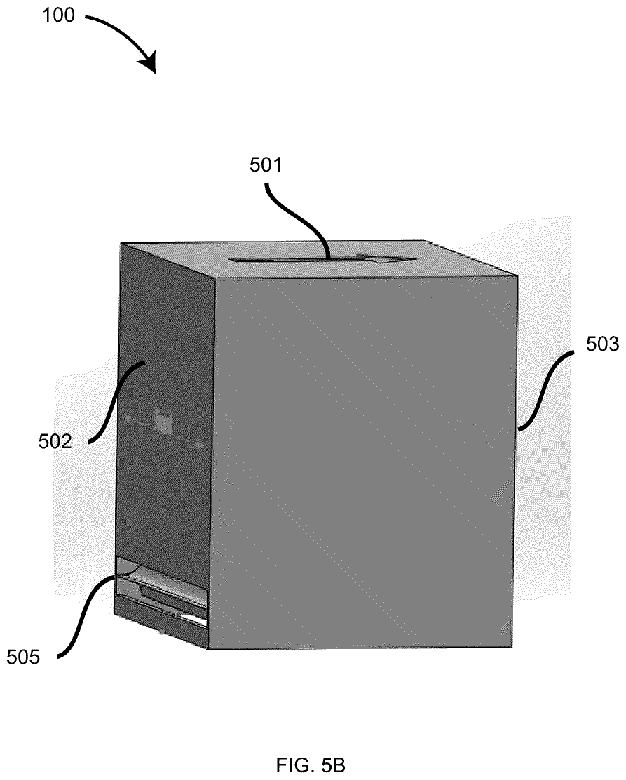

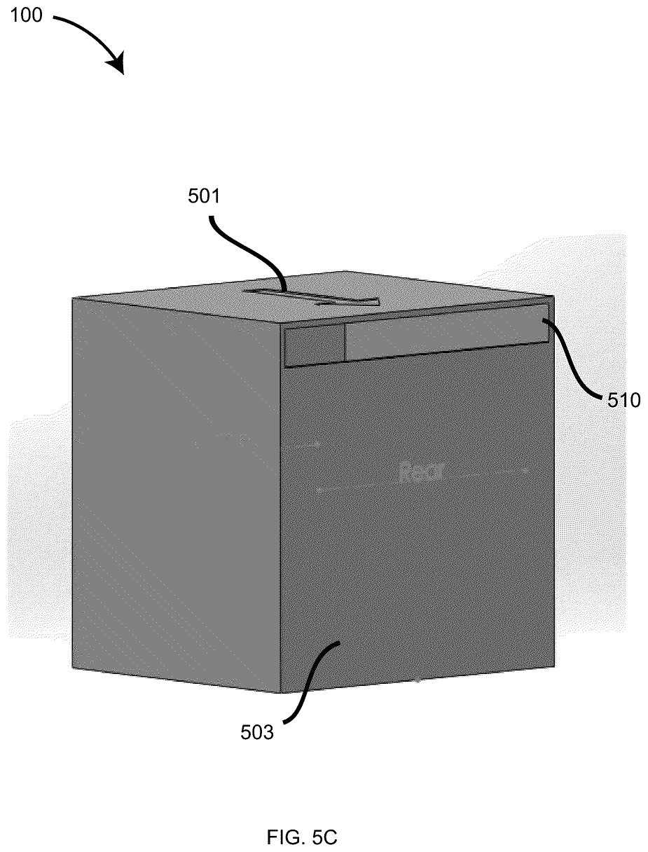

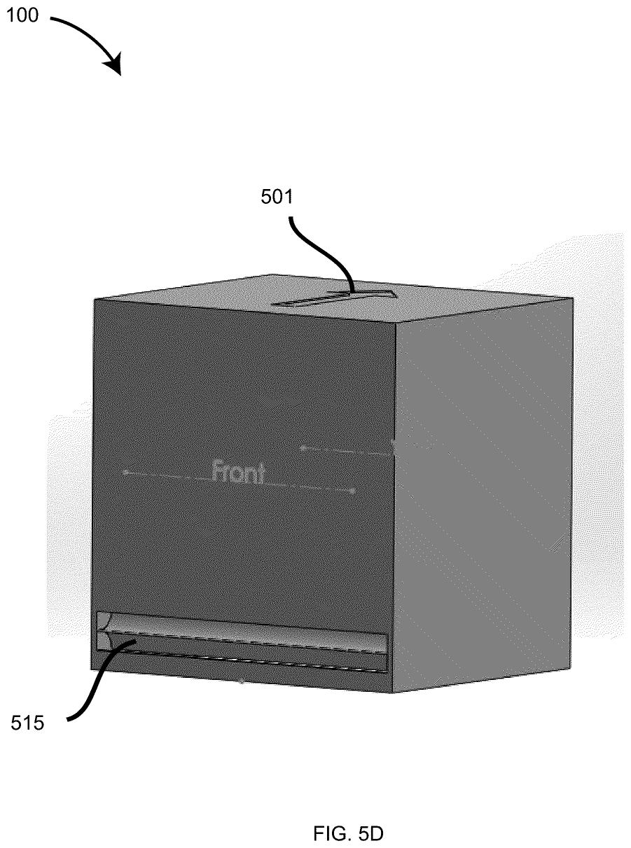

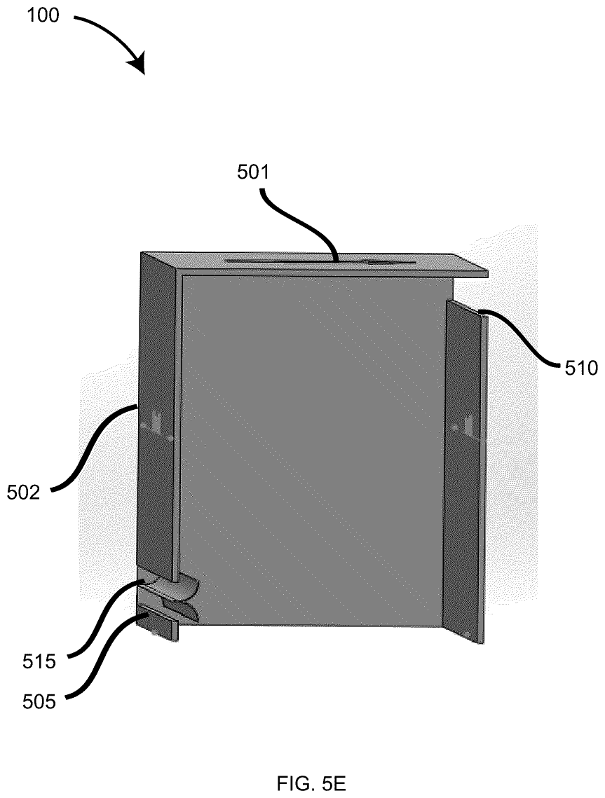

Referring to FIG. 5A, the suppressant container 12 can be positioned on top of a structure 126 (e.g., a bench, a stool, a pair of legs, a pallet, etc.) such that a space 128 is formed between a bottom of the suppressant container 12 and the ground surface 118. The space 128 may also be configured to receive forks of a forklift or machine for moving the suppressant container 12. The suppressant container 12 may be elevated a distance 124 from the ground surface 118. When air enters the inner volume 104 (e.g., through an inlet), the air may pass underneath the suppressant container 12 through the space 128 to facilitate cooling of the suppressant container 12 on multiple sides.

Referring still to FIG. 5A, outer container 100 can include one or more vents, actuators, louvres, deflectors, directors, etc., shown as baffles 140. The baffles 140 can be positioned proximate a transition between the inner volume 104 and the inner volume of the upper portion 106 and are configured to direct air from outside the outer container 100 towards the suppressant container 12. The baffles 140 may direct the air flow towards the suppressant container 12 to facilitate better air circulation around the suppressant container 12. It should be understood that the baffles 140 may be used in any of the configurations of the outer container 100 as shown in FIGS. 2-7D. The baffles 140 can be fixedly coupled on the outer container 100, or may be pivotally coupled such that an orientation or angle of the baffles 140 changes with respect to changes in wind direction.

Referring still to FIG. 5A, the outer container 100 can include a first upper portion 106a and a second upper portion 106b. The first upper portion 106a defines an opening 120a (e.g., an inlet) and the second upper portion 106b defines an opening 120b (e.g., an outlet). The opening 120a, the inner volume 104, and the opening 120b define a flow path from an exterior of the outer container 100, about the suppressant container 12, and out to the exterior of the outer container 100.

FIG. 5B is a perspective view of the front of an outer container 100. In this example and for purposes of this discussion, the arrow 501 points from the “front” 502 of the outer container 100 and toward the “back” 503 of the outer container 100 and depicts the direction of air flow such that the air may flow from the front 502 of the outer container 100 and toward the back 503 of the outer container 100. It may be understood that the designations of “front” and “back” of the outer container 100 are also for discussion purposes only. Although the outer container 100 is illustrated as rectangular or square, the outer container 100 may be any shape. In the examples, in which the outer container 100 is cylindrical, the “front” 502 of the outer container 100 may be the area of the outer container 100 with the inlet and into which air may flow, while the “back” 503 of the outer container 100 may be the area of the outer container 100 with the outlet and the area in which air may exit the outer container 100.

In FIG. 5B, the outer container 100 includes an airflow inlet 505 positioned in the front, lower portion of the outer container 100. The airflow inlet 505 is illustrated as extending the full width of the outer container 100 but may also be smaller than the full width. In some examples, the airflow inlet 505 may be 80% of the full width, 75% of the full width, 50% of the full width, 33% of the full width, 25% of the full width and so forth. In one example, the airflow inlet 505 may be 80% of the full width of the outer container 100. In this example, the airflow inlet 505 may be centered with respect to the width of the outer container 100, may be aligned with the left edge of the outer container 100, may be aligned with the right edge of the outer container 100, or may be offset to one side of the outer container 100 or the other. The airflow inlet 505 is also depicted in FIG. 5B as being at least approximately parallel to the edge of the outer container 100 but may also be non-parallel in some examples. In FIG. 5B, the edges of the airflow inlet 505 are also illustrated as being approximately straight edges and approximately rectangular. The shape of the airflow inlet may be any shape with any number of sides including, but not limited to, circular, square, trapezoidal, oval, quadrilateral, triangular, cloud-shaped, semi-circlular, octagonal, and so forth.

Additionally, the airflow inlet 505 is located in the bottom half of the outer container 100 and is approximately 20% of the height of the bottom half of the outer container 100. Similar to the width of the airflow inlet 505, the height of airflow inlet 505 may be any height of the outer container 100, although in some embodiments, the height of the airflow inlet 505 may be less than half the total height of the outer container 100 and oriented in the lower half of the front of the outer container 100. In some examples, there may be more than one airflow inlet 505 and/or more than one airflow outlet 510 in the outer container 100. Moreover, the airflow inlet 505 and the airflow outlet 510 may be located on more than one side and in some examples, may both be located on the same side. When the airflow inlet and the airflow outlet are located on the same side, louvers and/or a cover may be employed to close one of the airflow inlet or outlet.

In FIG. 5B, the louver is shown as positioned on the inside of the outer container 100. In some examples, the airflow inlet 505 may include louvers and/or slats on the inner or outer portion of the outer container 100. When one or more louvers are positioned proximate to the airflow inlet 505, the louvers may be used to direct the airflow to different areas of the inside of the outer container 100. The louvers may be partially or all the way open depending on the desired amount of cooling and ambient conditions. In the example employing multiple louvers, one or more louvers may be open or closed and alternating louvers or any number of louvers may be open to allow air to flow into the internal chamber of the outer container 100. The positioning of the louvers may be controlled from the inside and/or outside of the outer container 100 and also may be controlled electronically via wired and/or wireless network protocols, including but not limited to blue tooth, wi-fi, IEEE 802.11ah, Zigbee, IEEE 802.11, IEEE 802.11g, and so forth. In some examples, no louvers may be used, the airflow inlet 505 may be protected by a screen or filter, and/or only a portion of the airflow inlet 505 may be protected. Further, the airflow inlet 505 may include a cover that may cover a portion or all of the airflow inlet 505 when no airflow intake may be desired.

The airflow inlet 505 may allow air to enter the outer container 100, due at least in part to an air pressure differential (e.g., velocity head) between the front side 502 of the outer container 100 and the back side 503 of the outer container 100. Put another way, the difference in velocity induced pressure between the forward (front) and leeward (back) side of the outer container 100 may have a pressure differential that drives air to flow in and out of the outer container 100. As depicted in FIGS. 5B-5E, the outer container 100 may surround a suppressant container 12. The outer container 100 may enable airflow to circulate on all sides of the suppressant container 12, including below the fire suppressant container 12. The terms “suppressant container” and “fire suppressant container” may be used interchangeably herein.

FIG. 5C is a perspective view that illustrates the back of the outer container 100 of FIG. 5B and the airflow outlet 510. Similar to FIG. 5B, the arrow 501 indicates the direction of the air flow for discussion purposes only. The airflow outlet 510 may be located anywhere on the back of the outer container 100 and in some examples may be positioned anywhere in the upper portion of the back of the outer container 100. Put another way, in some examples, the airflow outlet 510 may be positioned from approximately toward the middle or above of the back side of the outer container 100. The airflow outlet 510 may include similar or the same properties of the airflow inlet 505 of FIG. 5B. That is, the airflow outlet 510 may include one or more louvers and/or slats, or may not include one or more louvers and/or slats, the airflow outlet 510 may be any shape, size, and/or position, the airflow outlet 510 may be controlled manually or via a wired or wireless network, and so forth. Specifically, like the airflow inlet 505, the airflow outlet 510 may be any shape, location, orientation, and/or position in the back of the outer container 100.

In the examples of FIG. 5B and FIG. 5C, the front of the outer container 100 may include an airflow inlet 505 located toward the bottom edge of the outer container 100 and the back of the outer container 100 may include an airflow outlet 510 located toward the top edge of the bottom container.

FIG. 5D is a perspective view of the outer container 100 and FIG. 5E is a side sectional view of the outer container 100. As depicted in the example of FIGS. 5D and 5E the airflow inlet 505 may include a louver 515 and the airflow outlet 510 may not include a louver or slat and may be open to ambient air. In other examples, neither or both of the airflow inlets 505 and airflow outlets 510 may include one or more louvers or the airflow inlet 505 may not have a louver and the airflow outlet 510 may include one or more louvers. Any combination of at least airflow inlets, airflow outlets, locations on a single side or more than one side, positions, sizes, orientations, number of airflow inlets and outlets, louvers, covers, and so forth, may be used with the outer container 100.

Referring to FIG. 6, outer container 100 may include multiple upper portions 106 having different orientations. For example, the first upper portion 106a can be oriented in a first direction to receive winds from a side of the outer container 100 (e.g., a longitudinal side) and the second upper portion 106b can be oriented in a second direction (e.g., 90 degrees relative to the first upper portion 106a, or another angle) in order to receive winds from another side of the outer container 100 (e.g., side winds). Advantageously, providing multiple inlets for the outer container 100 that are oriented in different directions may facilitate improved airflow into the outer container 100 and thereby improve cooling of the suppressant container 12.

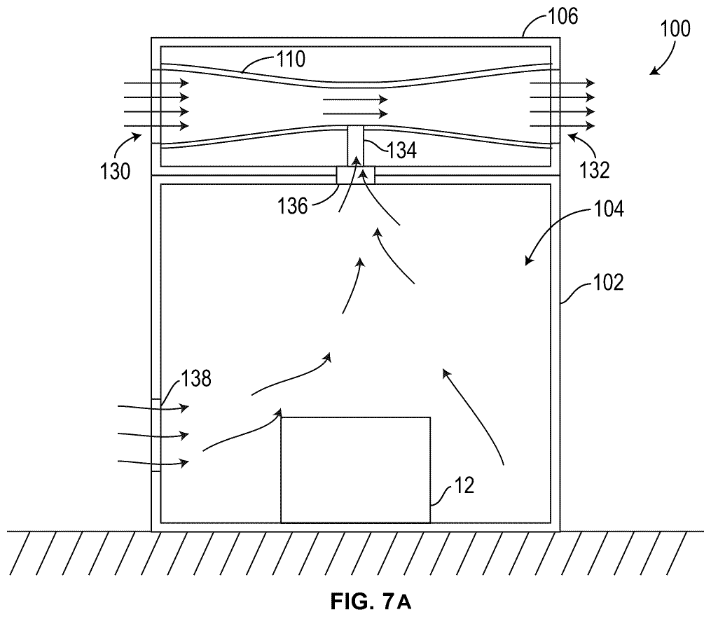

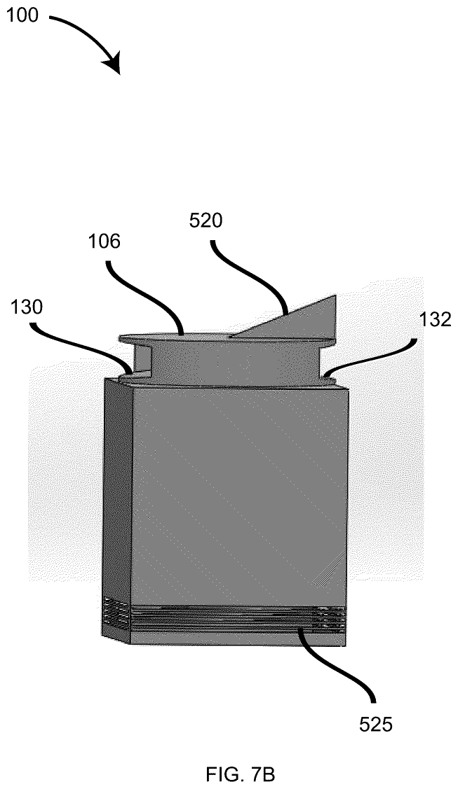

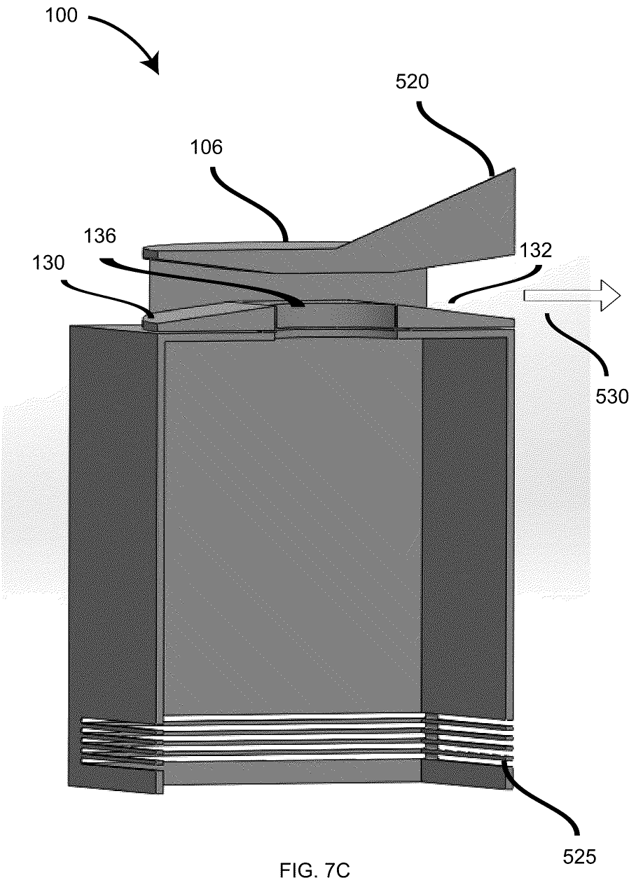

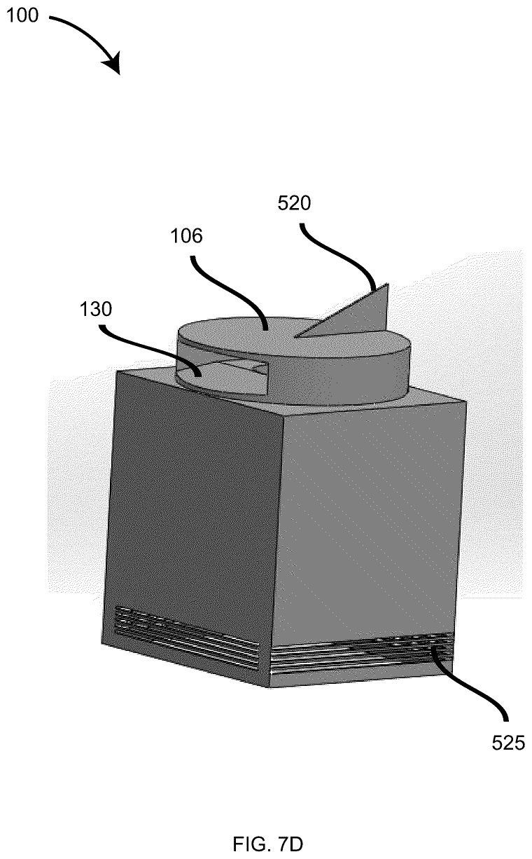

Referring to FIG. 7A, the upper portion 106 may include or define a venturi channel 110 that extends across the top of the main portion 102. The venturi channel 110 includes a first opening, shown as inlet 130, and a second opening, shown as outlet 132. The outer container 100 may include a channel 134 and an opening 136 that fluidly couples the inner volume 104 of the main portion 102 (within which the suppressant container 12 is positioned) with the venturi channel 110 of the upper portion 106 at a constricted portion of the venturi channel 110. Due to the constricted area of the venturi channel 110, a suction pressure may be created by air travelling through the venturi channel 110 which draws air from the inner volume 104 into the venturi channel 110. The main portion 102 may include an opening 138 (e.g., a window, a hole, an aperture, etc.) through which air can be drawn due to the flow of air from the inner volume 104 of the main portion 102 into the venturi channel 110. Advantageously, the flow of air through the opening 138 and into the venturi channel 110 facilitates cooling of the suppressant container 12.

FIGS. 7B and 7D are different perspective views of the outer container 100 with an inlet 130 to the venturi channel and a wind vane 520. In FIGS. 7B and 7D, the outer container 100 includes the upper portion 106 that at least partially defines the venturi channel (not shown). As described herein with reference to FIG. 7A, air may flow in through the opening 138 (in FIG. 7B opening 525) and out through the outlet 132. Because the outer container 100 uses airflow to cool the suppressant container 12 (not shown), the wind vane 520 may rotate so that the inlet 130 may face into the wind. By including the rotating upper portion 106 and wind vane 520, additional air may flow through the venturi channel to assist with cooling. The upper portion 106 may rotate freely and may depend at least partially on the wind direction. In some embodiments, there may be a lock on the upper portion 106 so that the upper portion 106 may be held in a position. Additionally, in some embodiments, the wind vane 520 may be removable from the upper portion 106 of the outer container 100. Although the wind vane 520 is depicted as a triangular shape, the wind vane 520 may be any shape and/or dimension that may assist with rotating the upper portion 106 to cool the outer container 100. The opening 525 toward the bottom of the outer container 100 may also be any shape, size, orientation, and may include louvers, slats, filters, and so forth, and any combination thereof, to facilitate air flow in the outer container 100.

FIG. 7C is a side sectional view of the outer container 100 of FIGS. 7B and 7D. The outer container 100 includes the inlet 130 and outlet 132 in the upper portion 106. FIG. 7C also depicts the opening 136 to the venturi channel with air flowing in the direction of the arrow 530. As previously described with reference to FIGS. 7B and 7D, the wind vane 520 may assist with the rotation of the upper portion 106 depending on the direction of the wind and/or air flow in ambient conditions. Additionally, the opening 525 toward the bottom of the outer container 100 may be any size, shape, orientation, and may include louvers, slats, filters, and so forth, and any combination thereof, to facilitate air flow in the outer container 100.

Referring to FIGS. 2, 4, and 6, the main portion 102 may include a trap door 116 that is positioned along a base or bottom of the main portion 102 (e.g., along a bottom edge). The trap door 116 is configured to define an opening for one or more tubular members (e.g., the conduits 20) to extend such that the suppressant container 12 can be fluidly coupled with a discharge system. The suppressant container 12 can discharge the fire suppressant agent through the conduits 20 without removal of the outer container 100.

Referring to FIGS. 2-6, the outer container 100 may have a square shape and six sides (e.g., including or lacking a bottom side, or including an opening in the bottom side). In other embodiments, the outer container 100 has a different number of sides (for example, the outer container may be triangular, hexagonal, octagonal, etc.). The outer container 100 may provide ventilation and enhanced cooling of air entering the interior volume and may be used as a cooling system for the suppressant container 12 in hot environments (e.g., ambient temperatures in excess of 140 degrees Fahrenheit).

The outer container 100 may be removable (e.g., from the ground surface 118) and may be portable such that the outer container 100 can be moved from one area to another to provide forced convective cooling to a different suppressant container 12 or a different object. In one embodiment, the outer container is manufactured from a plastic material. In other embodiments, the outer container 100 is manufactured from a composite or a ceramic material.

Referring to FIGS. 2-7D, the outer container 100 can include any number of inlets or outlets, shown as openings 120. The openings 120 are provided to receive a flow of air so that the air is directed to the inner volume 104. The openings 120 may be oriented in any direction to acquire cross winds. By providing multiple openings 120, each opening 120 may face in a respective direction (see FIG. 6), so that the outer container 100 can operate to deliver the flow of air to the suppressant container 12 irrespective of the prevailing wind direction. In some embodiments, by providing multiple openings 120, where multiple openings 120 face in the same direction (see e.g., FIG. 4), the outer container 100 can operate to deliver the flow of air to the suppressant container 12 with an increased force or volume of wind in one direction. In some embodiments, the openings 120 may also act as outlets to form a return path for stale and/or warm air exiting the inner volume 104, or if wind direction changes.

Referring particularly to FIGS. 3 and 5A, outlets (e.g., the second opening 120b, or the opening 122) are shown on different sides of the housing of outer container 100 relative to the inlets (e.g., the opening 120 or the first opening 120a). The outlets may be used as a return path for stale or warm air to exit the inner volume 104 of the outer container 100. The outlets may be located on any side of the outer container 100. Accordingly, the outer container 100 may include outlets in a variety of different locations such as the outer top housing (see FIG. 5A), or a sidewall (see FIG. 3) or any number of different positions that are elevated relative to the ground. In some embodiments, the outer container 100 may be provided with more than one outlet on any side of the outer container 100 as to allow air flow to exit.

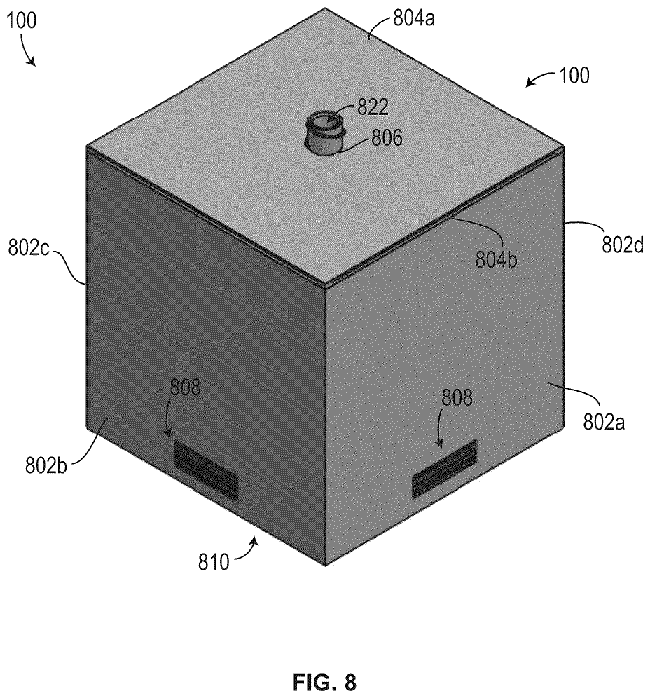

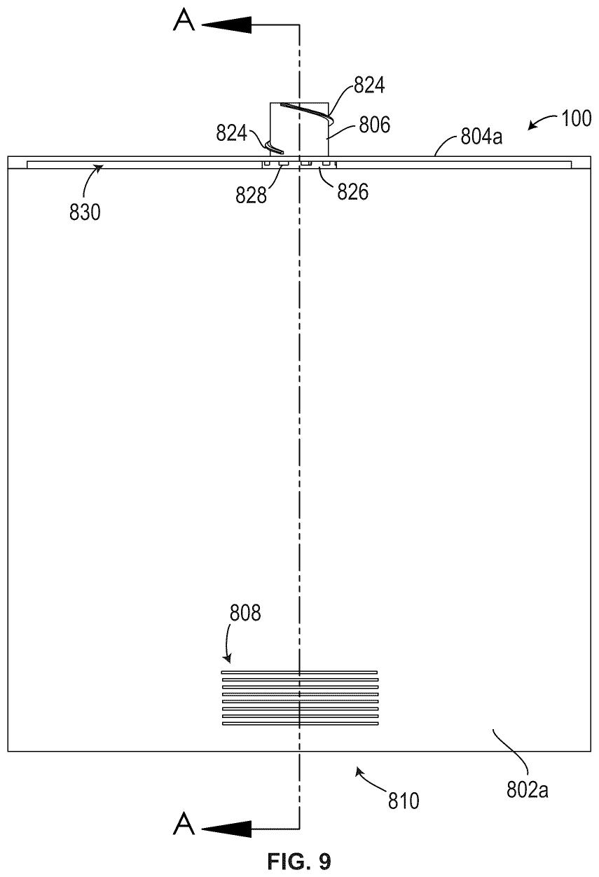

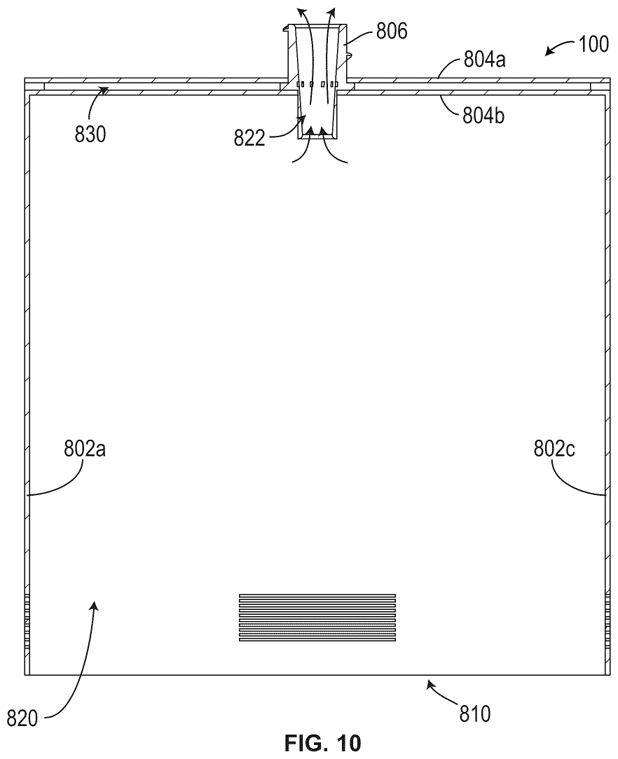

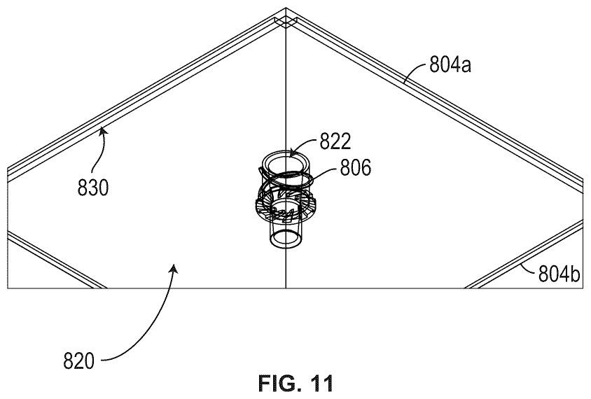

Referring to FIGS. 8-11, the outer container 100 may be provided as a box including multiple walls that form an inner volume. FIG. 10 is a cross section taken along line AA of FIG. 9. The outer container 100 may include a first ceiling 804a, a second ceiling 804b (e.g., a pair of panels, planar members, surfaces, etc.), sides 802 (e.g., a first side 802a, a second side 802b, a third side 802c, and a fourth side 802d), and a bottom 810. In some embodiments, the bottom 810 is open such that the outer container 100 may be placed over the suppressant container 12. The sides 802 may have the form of planar surfaces, plates, etc. The sides 802 may each include a vent 808 that fluidly couples an exterior of the outer container 100 with an inner volume 820 of the outer container 100.

The first ceiling 804a and the second ceiling 804b are offset or spaced apart from each other such that a gap 830 (e.g., a space, an inlet, etc.) is formed. The gap 830 may be formed on all four sides of the outer container 100. The gap 830 is configured to allow the ingress of air or wind from multiple sides of the outer container 100 into the space between the first ceiling 804a and the second ceiling 804b. The outer container 100 also includes a vortex member 806 that is configured to provide a vortex to thereby produce a low pressure area and induce flow of warm air out of the inner volume 820 of the outer container 100 through a channel 822 defined centrally in the vortex member 806. The vortex member 806 may be positioned centrally on the ceiling 804a and the ceiling 804b and is configured to receive air or wind that passes through the gap 830. The vortex member 806 includes a receiving portion 826 that extends between the ceiling 804a and the ceiling 804b and defines one or more openings 828 that fluidly couple the space between the ceiling 804a and the ceiling 804b with the channel 822 of the vortex member 806. The openings 828 may extend in a radial or angled pattern such that air that flows through the openings 828 and into the channel 822 which produces vortices and a low pressure region in the channel 822. The low pressure region within the channel 822 may cause warm air within the inner volume 820 to be drawn out of the outer container 100 such that passive cooling of the inner volume 820 and the suppressant container 12 is performed.

Referring still to FIGS. 8-11, the vortex member 806 may include a portion that extends or protrudes from the ceiling 804a. The vortex member 806 may include ribs 824 (e.g., spiral ribs) that extend along an outer surface of the portion of the vortex member 806. The ribs 824 may facilitate cooling of the portion of the vortex member 806 that extends outwards past the ceiling 804a.

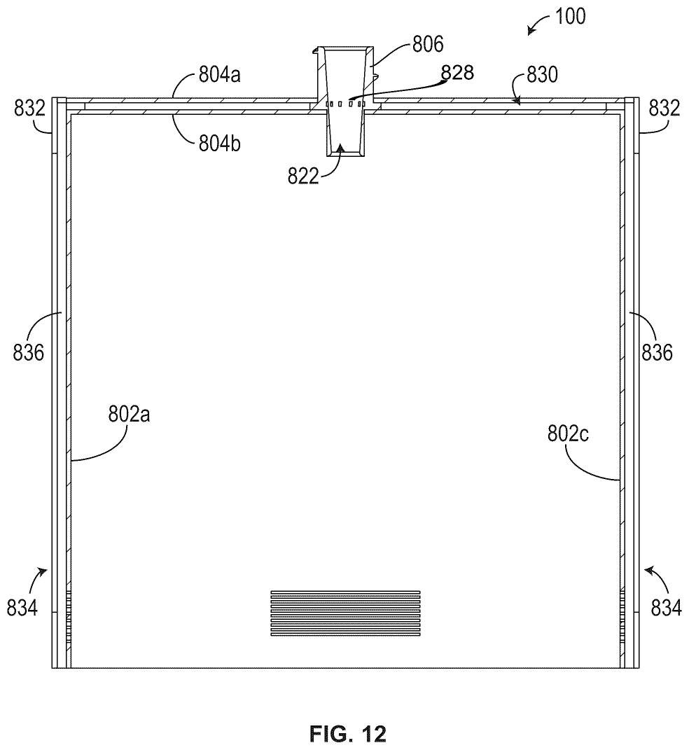

Referring to FIG. 12, each of the sides 802 may have a double wall and include a wall 832 spaced a distance from the sides 802 such that an inner volume 836 is defined between each of the sides 802 and the walls 832. The inner volume 836 may fluidly couple with the gap 830 that is between the ceiling 804a and the ceiling 804b. Each of the walls 832 may include an opening 834 such that the opening 834 facilitates the ingress of air or wind into the inner volume 836. Winds may blow from multiple sides towards the outer container 100, be received through the openings 834, travel through the inner volume 836 to the gap 830, travel through the gap 830 between the ceiling 804a and the ceiling 804b and enter the vortex member 806 through the openings 828. The wind may be used to produce a vortex and a low pressure region within the channel 822 to thereby cause warm air to be expelled or discharged from the inner volume 836 to induce forced convective cooling of the suppressant container 12 which may be positioned within the inner volume 836.

### Configuration of the Exemplary Embodiments

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of baffle 140 of the exemplary embodiment shown in at least FIGS. 5A-5E may be incorporated in the outer container 100 of the embodiment shown in at least FIG. 7A-7D or 3. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An outer container for cooling a fire suppressant container, comprising:
a housing configured to at least partially enclose the fire suppressant container that stores a fire suppressant agent, the housing comprising:
sidewalls defining an inner volume configured to surround the fire suppressant container;
an inlet configured to be positioned at an elevated position relative to a ground surface to receive air from an environment outside of the housing; and
an outlet, wherein:
the inner volume, the inlet, and the outlet define a flow path for air such that the air flows through the outer container and proximate the fire suppressant container to induce forced convective cooling of the fire suppressant container.

2. The outer container for cooling the fire suppressant container of claim 1, wherein:
the fire suppressant container further comprises a tubular member;
the sidewalls comprise an opening configured to receive the tubular member such that the tubular member extends into the housing from outside; and
the tubular member fluidly coupled with the fire suppressant container for discharge of the fire suppressant agent through the tubular member to a zone located outside of the outer container for fire suppression.

3. The outer container for cooling the fire suppressant container of claim 2, wherein the fire suppressant container is configured to provide the fire suppressant agent through the tubular member to at least one of a discharge device or an induction system.

4. The outer container for cooling the fire suppressant container of claim 1, wherein the housing comprises multiple inlets and multiple outlets, the multiple inlets configured to catch the air to direct air flow into the inner volume and out through the outlet in different directions.

5. The outer container for cooling the fire suppressant container of claim 1, wherein the housing further comprises a baffle configured to direct the air from the inlet towards the fire suppressant container.

6. The outer container for cooling the fire suppressant container of claim 1, wherein:
the outer container is configured to elevate the fire suppressant container relative to the ground surface such that a space is defined between a bottom of the fire suppressant container and the ground surface; and
the space is configured to receive air underneath the fire suppressant container to cool at least the fire suppressant container.

7. The outer container for cooling the fire suppressant container of claim 1, wherein the housing is configured to facilitate access to the fire suppressant container.

8. The outer container for cooling the fire suppressant container of claim 1, wherein:
the outer container further comprises an upper portion defining a channel;
the inlet and the outlet are positioned in the upper portion; and
the channel allows the air to flow therethrough via the inlet and the outlet.

9. The outer container for cooling the fire suppressant container of claim 8, further comprising a wind vane proximate the upper portion of the outer container.

10. The outer container for cooling the fire suppressant container of claim 8, wherein the upper portion of the outer container rotates to facilitate the air flow.

11. The outer container for cooling the fire suppressant container of claim 1, wherein:
the sidewalls further comprise a first side, a second side, a third side, and a fourth side;
the inlet is positioned in a bottom half of the first side of the sidewalls; and
the outlet is positioned in a top half of the second side of the sidewalls.

12. The outer container for cooling the fire suppressant container of claim 11, wherein the first side is different than the second side.

13. The outer container for cooling the fire suppressant container of claim 11, wherein the first side is positioned opposite the second side in the housing.

14. An outer container for cooling a suppression container, the outer container comprising:
a plurality of sidewalls configured to surround a suppression container and encasing an inner volume;
an upper portion above and abutting the plurality of sidewalls;
an inlet being elevated relative to a ground surface upon which the plurality of sidewalls stand; and
an outlet being elevated relative to the ground surface upon which the plurality of sidewalls stand, wherein the inner volume, the inlet, and the outlet define a flow path for the air to flow therethrough, such that the air flows to induce forced convective cooling of the suppression container.

15. The outer container of claim 14, wherein:
the inlet and the outlet are positioned in the upper portion; and
the upper portion rotates to facilitate air flow.

16. The outer container of claim 15, the upper portion further comprising a wind vane formed on the upper portion of the outer container, wherein the wind vane facilitates rotation of the upper portion of the outer container.

17. The outer container of claim 15, further comprising an opening in each of the plurality of sidewalls, wherein the openings are each positioned in a bottom half of each of the plurality of sidewalls to facilitate the air flow through the outer container.

18. An outer container for cooling a suppression container, the outer container comprising:
a housing configured to at least partially enclose the suppression container that stores a fire suppressant agent, the housing comprising:
an inlet configured to be positioned at an elevated position relative to a ground surface to receive air from an environment outside of the housing; and
an outlet, wherein an inner volume, the inlet, and the outlet define a flow path for the air such that the air flows through the outer container and proximate the suppression container to induce forced convective cooling of the suppression container.

19. The outer container of claim 18, wherein:
the housing forms an internal compartment and is configured to encase the suppression container such that the air flows between the suppression container and the outer container.

20. The outer container of claim 19, further comprising:
an upper portion formed toward a top of the outer container;
a channel formed between the inlet and the outlet allowing the air to flow therethrough;
an opening between the upper portion and the internal compartment allowing the air to flow therethrough;
the upper portion is configured to rotate to facilitate air flow through the outer container; and
a wind vane formed on the upper portion configured to rotate the upper portion based at least in part on a direction of ambient air flow.
